(19) United States
(12) Patent Application Publication
(10) Pub. No.: US 2024/0403731 A1
(43) Pub. Date: Dec. 5, 2024

(54) METHODS OF SELECTING AND ASSIGNING PLANE SEATS

(71) Applicant: Paul Casey, Lafayette, LA (US)

(72) Inventor: Paul Casey, Lafayette, LA (US)

(21) Appl. No.: 18/678,241

(22) Filed: May 30, 2024

Related U.S. Application Data
(60) Provisional application No. 63/505,682, filed on Jun. 1, 2023.

(51) Int. Cl. G06Q 10/02; G06Q 50/40

(52) U.S. Cl. CPC G06Q 10/02; G06Q 50/40

(57) ABSTRACT

A method of assigning seats includes receiving a booking request from a customer, the booking request including a passenger age designation for each passenger to identify each passenger as an adult or a child, identifying an aircraft with seats of different sizes including at least one standard seat of a first width and at least one reduced seat of a second width, confirming availability of at least one empty seat with a size corresponding to the passenger age designation for each passenger, and calculating a total fare that is a sum of (i) a first product of a standard fare for a standard seat and a number of adults, and (ii) a second product of a reduced fare for the at least one reduced seat and a number of children.

### CROSS-REFERENCE TO RELATED APPLICATIONS

The present application claims priority to U.S. Provisional Ser. No. 63/505,682, filed on May 30, 2024, the contents of which are hereby incorporated by reference as if fully set forth herein.

### TECHNICAL FIELD

The present disclosure relates generally to a method of assigning seats on an aircraft. More specifically, the present disclosure relates to seat assignment within an aircraft based on selected criteria.

### BACKGROUND OF THE SPECIFICATION

Commercial airlines and airplane manufacturers aim to optimize the configuration of passenger seats to maximize revenue generation and minimize operating expenses per seat. When it comes to existing airplane cabin configurations, the seat arrangements are designed to prioritize passenger comfort without compromising on the number of seats or to maximize the number of seats while maintaining a certain level of comfort. The conventional approach to designing new airplane seating arrangements focuses on a uniform size of seats within each class of service (economy, premium economy, business, first class) while accommodating a specific number of seats at the comfort level desired for each class.

In terms of seat arrangement, the primary principle for premium fare passengers is to prioritize maximum comfort by providing wider seats and increased distance between a seat and the seat in front of it (i.e., leg room). Seat arrangement for economy class passengers prioritizes a more basic level of comfort with a standard seat width and distance between rows that is closer to the minimum required to accommodate the body size of the majority of adults.

On the other hand, passengers consider various factors when deciding on their choice of flight, such as the destination, the number of layovers, ticket price, and seat comfort. The level of seat comfort is primarily determined by the class of the seat (e.g., economy, or business). Assuming the flight is non-stop and the destination is fixed, the remaining factors that influence a premium class passenger's ticket purchase are the level of seat comfort, quality of food and beverage, and attentiveness of flight attendants with price not necessarily being a primary concern while for economy passengers, price is typically the primary concern.

To maximize profits, airlines are generally forced to choose between increasing the price per seat or increasing the number of seats on the aircraft. In current practice, increasing the number of seats on an aircraft of a given size can only be achieved by reducing personal space for passengers and/or reducing amenities such as food galleys, the number of toilets and closet space. For example, it has been common practice to strive to increase the load factor, which refers to the percentage of occupied seats on a flight. However, achieving higher load factors has typically involved reducing ticket prices, which can lead to a decrease in airline fare revenue. Another approach to increase revenue is by raising ticket prices, provided that the increase does not discourage passengers from purchasing tickets. Striking a balance between generating more revenue, ensuring passenger comfort, and offering an acceptable ticket price is a challenging task.

Hence, the instant disclosure seeks to introduce a seating type and arrangement and a seating assignment system that increases airline revenue while maintaining the level of passenger comfort and amenities while meeting the demands of customers for economical travel. By doing so, it aims to increase passenger capacity without reducing the distance between rows of seats and without reducing the width and number of standard seats, ultimately leading to a revenue boost.

### SUMMARY OF THE SPECIFICATION

In some examples, a method of assigning seats in an aircraft, comprising receiving a booking request from a customer, the booking request including a passenger age designation for each passenger to identify each passenger as an adult or a child, identifying an aircraft with seats of different sizes including at least one standard seat of a first width and at least one reduced seat of a second width, confirming availability of at least one empty seat with a size corresponding to the passenger age designation for each passenger, and calculating a total fare that is a sum of (i) a first product of a standard fare for a standard seat and a number of adults, and (ii) a second product of a reduced fare for the at least one reduced seat and a number of children.

### BRIEF DESCRIPTION OF THE SPECIFICATION

Embodiments of the presently disclosed airline seat assignment and arrangement systems are shown herein with reference to the drawings, wherein:

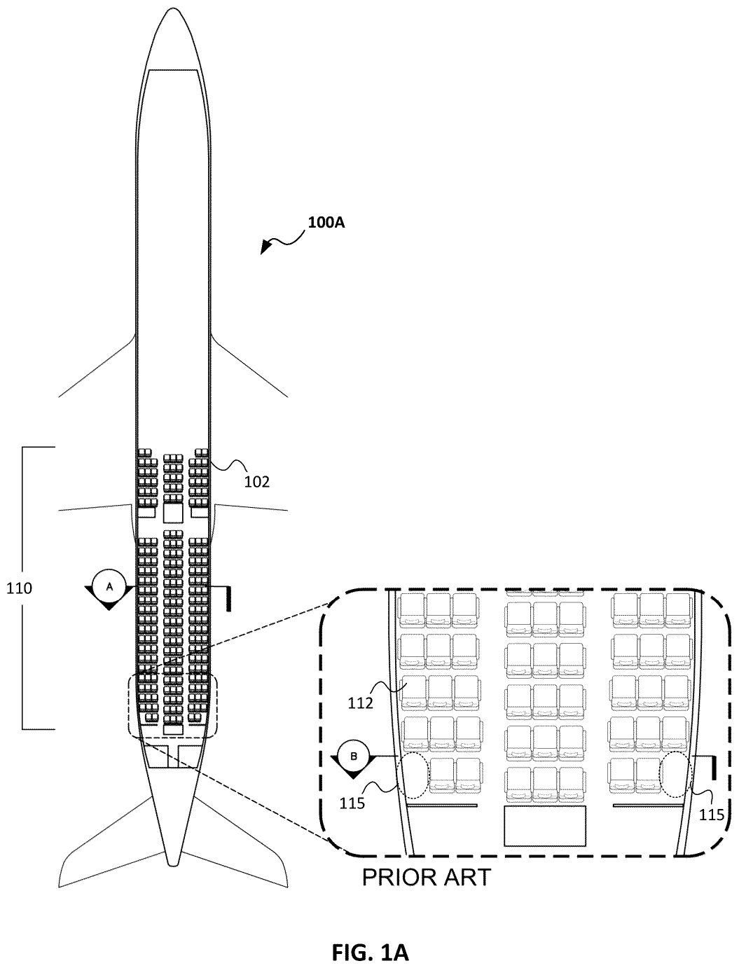

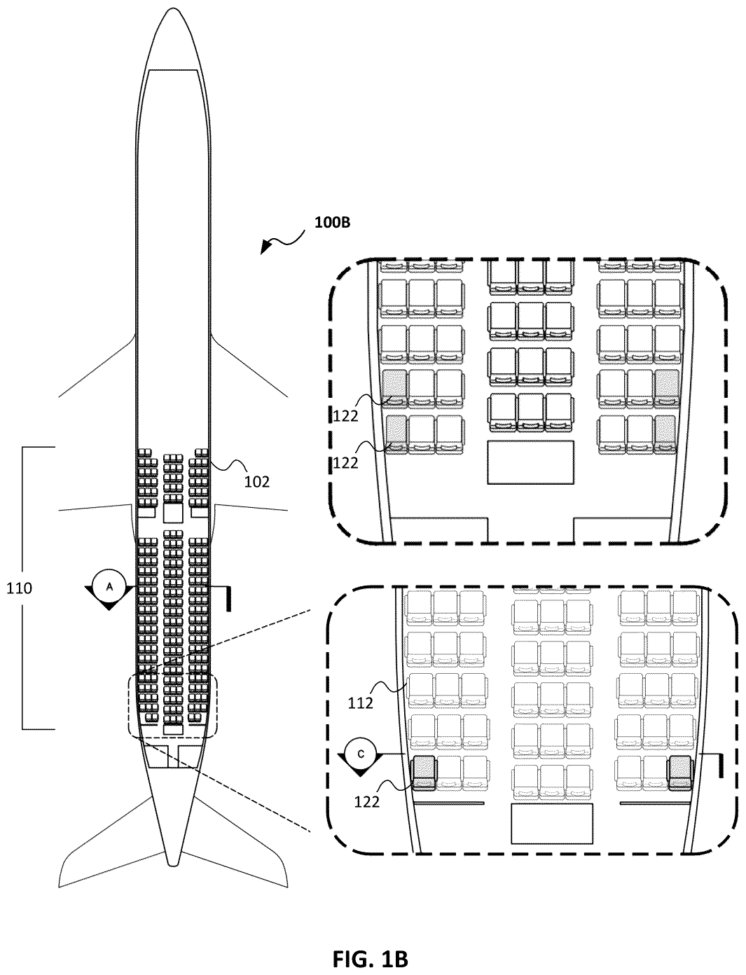

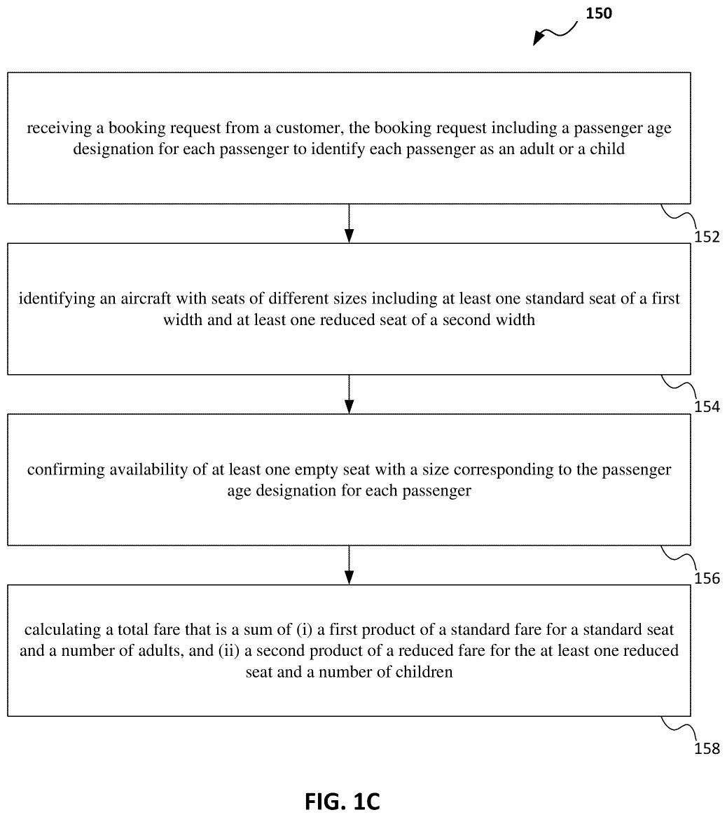

FIG. 1A is a schematic representation of an aircraft cabin showing unused space;

FIG. 1B is a schematic representation of an aircraft cabin showing the addition of child passenger seats;

FIG. 1C is a schematic flowchart shows a method of booking seats according to one embodiment of the present disclosure;

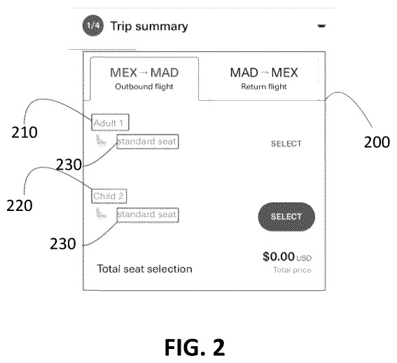

FIG. 2 is a schematic showing a booking method including a step of selecting a seat for an adult or a child;

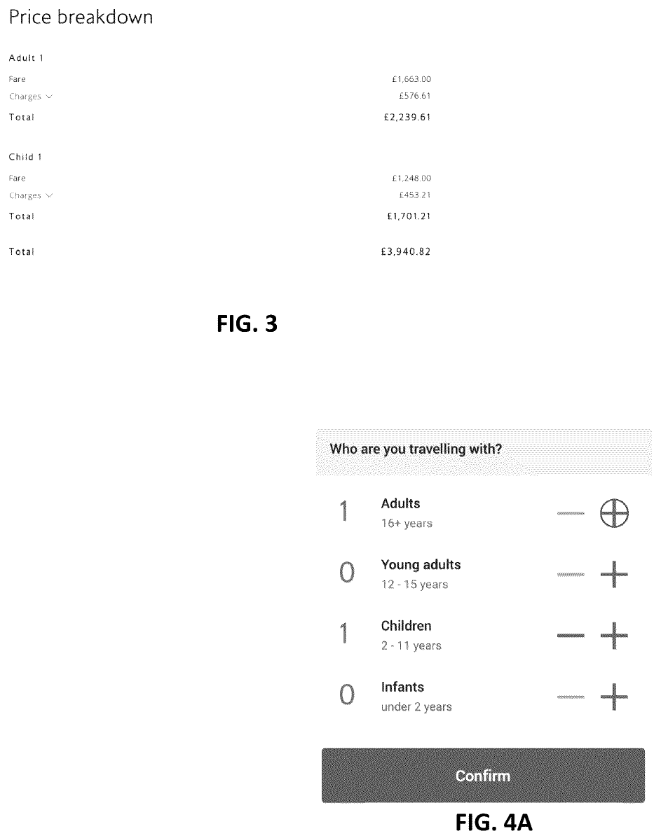

FIG. 3 depicts a price breakdown for a customer showing airline tickets for both an adult and a child;

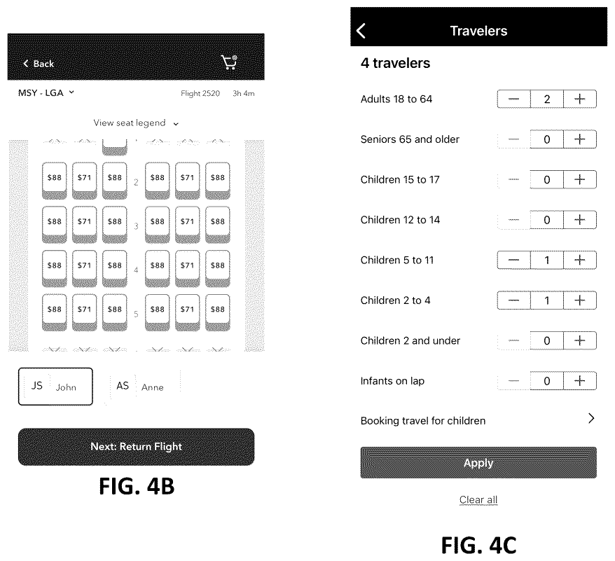

FIG. 4A is an example of how seating assignments are made based on age;

FIGS. 4B-C are examples of a booking system with seat pricing and an initial booking questionnaire to determine ages of passengers; and

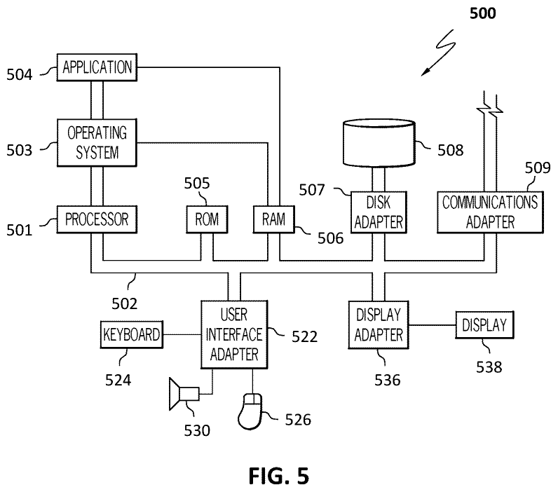

FIG. 5 illustrates a hardware configuration of a booking system in accordance with an embodiment of the present disclosure.

The embodiment of the present method will now be described with reference to the appended drawings. It is to be appreciated that these drawings depict only some embodiments of the method and are therefore not to be considered limiting of its scope.

### DETAILED DESCRIPTION

Despite the various improvements that have been made to airline seating assignment and arrangement methods, conventional methods suffer from some shortcomings as described above. There therefore is a need for further improvements to the methods, and systems of assigning and arranging airline seats. Among other advantages, the present disclosure may address one or more of these needs. Additionally, there is a need for further improvements to methods of bookings for families with young children.

The fuselage of an aircraft is designed to reduce fuel consumption by approximating the most aerodynamic shape which is a rounded nose at the front and a gradual tapering to a point at the rear. This shape reduces drag which is friction caused by the movement of air over the exterior of the aircraft when in flight. An aerodynamic form results in a passenger cabin that is not of a uniform width from the front to the middle, to the rear. Given the shape of aircrafts and the dimensions of the seats within a seat class, there are rows where fewer seats are installed. One example of such an instance is at the rear of the aircraft where the fuselage tapers to the point that it cannot accommodate the same number of seats as other rows on the aircraft in the same class of service. By way of illustration, FIG. 1A shows one arrangement for seats on an aircraft 100A. As shown, aircraft 100A includes a body 102 having a rear cabin 110. In this example, the rear cabin 110 includes a number of seats 112 disposed in rows. Generally, the seats 112 are disposed in rows, and in this example in a 3-3-3 arrangement. That is, each row includes a first group of three adjacent seats, an aisle, a second group of three middle three seats, a second aisle, and a third group of three adjacent seats. Thus, nine passengers in total are generally accommodated in each row. Variations of this arrangement are possible. For example, in FIG. 1A, the middle group of seats are slightly offset or staggered with respect to the terminal right and left groupings. Notice that all the seats are of a predetermined width. This predetermined width for a standard seat may vary between aircrafts and airlines, but in most cases, it is commonly 17 to 18 inches in width, and all the seats within a given class are the same and are designed to accommodate an adult.

In the closeup view, unusable spaces 115 are found in the last row or rows, which cannot be used. Specifically, due to the tapering of the fuselage, the aircraft width is smaller at the rear end of the plane such that the aircraft cannot accommodate nine seats in the last row as would be possible in other locations, while having a proper aisle width for safety. Thus, two unused spaces 115 are found in this particular aircraft, which are essentially dead space as they cannot accommodate a passenger, and are not suitable for luggage storage. It will be understood that this instant example is being shown only to illustrate the presence of empty spaces, and that these “dead space” areas may be found in other parts of the aircraft. Additionally, at the widest parts of an airplane, it may be possible to accommodate more than nine seats so that extra unused spaces are found in addition to a standard row of seats.

Turning now to FIG. 1B, another configuration of airplane seating will be described with reference to aircraft 100B. In this example, aircraft 100B includes a body 102 having a rear cabin 110. As described above, the rear cabin 110 includes a number of standard seats 112 of a first width (e.g., 17-18 inches) disposed in rows. Generally, the seats 112 are disposed in rows, and in this example in a 3-3-3 arrangement similar to that described above. That is, each row includes a first group of three adjacent seats 112, an aisle, a second group of three middle three seats 112, a second aisle, and a third group of three adjacent seats 112. Thus, nine passengers in total are generally accommodated in standard-sized seats 112 in each row. Here, instead of empty spaces 115, two reduced width seats 122 are disposed in the last row, shaded in gray by way of illustration. The reduced width seats 122 may have a reduced width that is less than the width of a standard seat (e.g., 16.5 inches, 16 inches, 15.5 inches, 15 inches, 14.5 inches, 14 inches, 13 inches, or less). Two reduced seats 122 are shown in the last row, although it will be understood that a row may include one reduced seat, two reduced seats, three reduced seats, four reduced seats or more.

In some examples, the reduced seats 122 are intended for child passengers with certain requirements of occupancy. The requirements may include an age restriction (e.g., the passenger in reduced seat 122 must be less than 12 years of age, 11 years of age, 10 years of age, 9 years of age, 8 years of age, etc.). The requirements may also include a weight restriction (e.g., the passenger in reduced seat 122 must be less than 120 lbs., 100 lbs., 90 lbs., 80 lbs., etc.). The requirements may also include both an age restriction and a weight restriction according to the examples described above. When intended for child passengers, each reduced seat 122 may be disposed directly adjacent a standard seat such that a child may sit in the reduced seat accompanied by a parent or guardian. With this arrangement, the passenger capacity of the aircraft is increased which lowers the carbon footprint per individual passenger, an ever-growing priority for regulatory agencies and airlines. Additionally, these reduced seats may be sold at a reduced fare, which is also a benefit to adults traveling with children who would pay a lower fare for the reduced width seat. For airlines that already offer reduced child fares for children occupying a standard width seat, incentivizing children to shift to a child width seat that has been added to the aircraft will make a standard width seat available to an adult fare passenger. Optional safety features may be added to child width seats such as those found on child car seats (e.g., neck support, five-point seat belt harness, etc.) but are not currently required by regulatory entities. Finally, the reduced width seat may be a benefit to other passengers by locating child passengers in a designated area with adult guardians, which reduces noise within the main cabin. Unaccompanied minors seated in child seats closest to flight attendant stations in the rear of the aircraft can be better monitored.

Many aircraft have unused cabin spaces, particularly in the economy section, where reduced width seats could be inserted for children paying the reduced child fare. Unused spaces that could accommodate child width seats typically occur towards the rear of the economy cabin where aircraft width is gradually tapering towards the tail of the aircraft and where the number of seats in each row is abruptly reduced to account for the narrowing cabin width. The cabin width narrows by only several inches per row of seats leaving enough empty space to add child seats in rows where the number of adult seats has been reduced. Where two consecutive rows of seats in the tapering portion cabin have adequate unused space to accommodate child seats, the child seats in the furthest aft row could be of narrower width and would be available only to passengers selecting small child during the reservation process. Additional unused potential space for child width seats can occur at the front of the economy cabin where two adjacent cabin classes have different seating configurations resulting in misaligned aisles and a reduction in the number seats in the first row of economy class to allow for passengers and service carts to pass. In some aircraft types, there is unused space towards the rear of the aircraft between two aisles. It would therefore be in the interest of aviation companies to maximize their aircrafts' passenger capacity and fare revenue by adding child fare seats, without reducing the number of seats that can accommodate passengers paying the pricier adult fare.

As shown in FIG. 1C, in some examples, a method of booking or assigning seats 150 includes receiving a booking request from a customer, the booking request including a passenger age designation for each passenger to identify each passenger as an adult, a child, small child or infant under two years of age (152), identifying an aircraft with seats of different widths for the same class of service including at least one standard seat of a first width and at least one reduced width seat of a second width (154), confirming availability of at least one empty seat with a size corresponding to the passenger age designation for each passenger (156), and calculating a total fare that is a sum of (i) a first product of a standard fare for a standard seat and a number of adults, and (ii) a second product of a reduced fare for the at least one reduced seat and a number of children (158). Selection of a standard width seat for a child could prompt a popup informing the customer that the ticket price would be a certain amount higher than for an available child seat (See, FIG. 4B). During the booking process, a visual representation of the aircraft may be shown to the customer with the available seats and a respective size and/or fare for each available seat. The reduced size/fare may be shown only as an option for customers who are booking for child passengers. Otherwise, adults may be restricted from accessing the reduced seats. The restrictions on the reduced seat may also be provided to the customer (e.g., age or weight restrictions), and the customer may verify or enter information to accept these restrictions. The customer may be prompted to select an alternative seat if the child does not meet the requirements of the at least one reduced seat. Airlines that currently offer discounts to children seated in standard seats could continue to do so but they would have the option to price standard seats for children higher than child seats.

FIG. 2 depicts an online form for booking airline tickets and choosing a ticket based on whether the passenger is a child or an adult as well as the type of seat the customer prefers to book for the child. In this example, screen 200 shows that a customer may select the adult option 210 or the child option 220. As the customers selects the passenger designation (e.g., adult or child), the seat options 230 may be displayed. The type of seat option 230 may display the text “standard seat” to indicate that the user is selecting the standard seat dimensions on an aircraft. The user may opt to choose the standard seat or a reduced seat for the child for a discounted fee. The same process can be repeated for a return flight. In some examples, a prompt or announcement may be made to the customer such as “REDUCED FARE AVAILABLE FOR QUALIFYING PASSENGERS” and show the available discount for the reduced seat.

In FIG. 3, the booking system may display price breakdown for each passenger prior to confirmation, and/or after completing the booking process. Here, the fare for the adult is shown, and a discounted fare (e.g., 10%, 20%, 25%, 33% or 40% discount from the standard fare) for the child is shown, the child fare being less than the adult fare. Notably, this discounted fare for the child may only be applied if the child is to be seated at a reduced seat. That is, a child may still occupy a standard seat by paying the standard rate for that seat. The depiction demonstrates a discounted price in relation to the standard adult size seat and the reduced seat.

FIG. 4A shows one example of a booking system that includes options for the user to choose the age of the passenger (e.g., Adult, Young Adult, Children, Infant). In some examples, this initial step may be used to determine or locate the available seats for each age group. Selecting one of the four options would show the user the recommended seat type for the age group. For the example in the figure, one adult and one child are selected which will show the user the available seats for both groups, showing the standard adult seats for the adult and the reduced seats for the child. It will be appreciated that though the disclosure has included an embodiment with seats of two widths (i.e., a standard seat and a reduced seat), the seats may instead be broken into three groupings (i.e., a standard seat for most adults, a reduced seat for children, and a relaxed seat for larger passengers), and that three different fares for each of these categories may be presented instead of two.

FIG. 5 illustrates an embodiment of a hardware configuration of booking system 500 which is representative of a hardware environment for practicing the present invention. Booking system 500 may have a processor 501 coupled to various other components by system bus 502. An operating system 503 may run on processor 501 and provide control and coordinate the functions of the various components of FIG. 2. An application 504 in accordance with the principles of the present invention may run in conjunction with operating system 503 and provide calls to operating system 503 where the calls implement the various functions or services to be performed by application 504. Application 504 may include, for example, an application for identifying, locating, selecting and assigning seats as described above.

Read-Only Memory (ROM) 505 may be coupled to system bus 502 and include a basic input/output system (“BIOS”) that controls certain basic functions of booking system 500. Random access memory (RAM) 506 and disk adapter 507 may also be coupled to system bus 502. It should be noted that software components including operating system 503 and application 504 may be loaded into RAM 506, which may be booking system 500 main memory for execution. Disk adapter 507 may be an integrated drive electronics (“IDE”) adapter that communicates with a disk unit 508, e.g., disk drive. It is noted that the application for identifying, locating, selecting and/or assigning seats, may reside in disk unit 508 or in application 504.

Referring to FIG. 5, booking system 500 may further include a communications adapter 509 coupled to bus 502. Communications adapter 509 may interconnect bus 502 with an outside network, e.g., Local Area Network (LAN), Wide Area Network (WAN), enabling booking system 500 to communicate with other such systems.

I/O devices (e.g., mobile phones, tablets, laptops, etc.) may also be connected to booking system 500 via a user interface adapter 522 and a display adapter 536. Keyboard 524, mouse 526 and speaker 530 may all be interconnected to bus 502 through user interface adapter 522. Data may be inputted to booking system 500 through any of these devices. A display monitor 538 may be connected to system bus 502 by display adapter 536. In this manner, a user is capable of inputting to booking system 500 through keyboard 524 or mouse 526 and receiving output from booking system 500 via display 538 or speaker 530.

The various aspects, features, embodiments or implementations of the invention described herein can be used alone or in various combinations. The methods of the present invention can be implemented by software, hardware or a combination of hardware and software. The present invention can also be embodied as computer readable code on a computer readable medium. The computer readable medium is any data storage device that can store data which can thereafter be read by a computer system. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

Although the method herein has been described with reference to particular embodiments, it is to be understood that these embodiments are merely illustrative of the principles and applications of the present method. It is therefore to be understood that numerous modifications may be made to the illustrative embodiments and that other arrangements may be devised without departing from the spirit and scope of the present method as defined by the appended claims.

It will be appreciated that the various dependent claims and the features set forth herein can be combined in different ways than presented in the initial claims. It will also be appreciated that the features described in connection with individual embodiments may be shared with others of the described embodiments.

What is claimed is:

1. A method of assigning seats in an aircraft, comprising:
receiving a booking request from a customer, the booking request including a passenger age designation for each passenger to identify each passenger as an adult or a child;
identifying an aircraft with seats of different sizes including at least one standard seat of a first width and at least one reduced seat of a second width;
confirming availability of at least one empty seat with a size corresponding to the passenger age designation for each passenger; and
calculating a total fare that is a sum of (i) a first product of a standard fare for a standard seat and a number of adults, and (ii) a second product of a reduced fare for the at least one reduced seat and a number of children.

2. The method of claim 1, further comprising the step of providing a visual representation of available seats and a respective size for each available seat.

3. The method of claim 1, further comprising the step of providing a visual representation of available seats and a respective fare for each available seat.

4. The method of claim 1, wherein receiving a booking request from a customer comprises a booking request for at least one child passenger.

5. The method of claim 4, further comprising the step of providing the customer with a choice of at least one standard seat and at least one standard seat reduced seat for the at least one child passenger.

6. The method of claim 1, further comprising the step of restricting an adult passenger from choosing any of the least one reduced seat.

7. The method of claim 1, further comprising the step of restricting the at least one reduced seat to passengers with requirements such that the passenger must be under twelve years of age and under one hundred pounds in weight.

8. The method of claim 7, further comprising the step of prompting the customer to select an alternative seat if the child does not meet the requirements of the at least one reduced seat.

9. The method of claim 1, wherein at least one reduced seat is disposed in a tapering portion of a fuselage of the aircraft.

10. The method of claim 1, further comprising the step of storing information from the booking.

11. The method of claim 1, further comprising the step of creating and storing a unique booking confirmation code that includes details of the booking request and the total fare.

12. The method of claim 1, further comprising the step of requiring the customer to submit a booking request having at least one adult passenger for each child passenger.

13. The method of claim 12, further comprising the step of seating the least one adult passenger adjacent each child passenger.

14. A method of seating passengers on an aircraft, comprising:
receiving a booking request from a customer, the booking request including a passenger age designation for each passenger to identify each passenger as an adult or a child;
locating seats of different sizes on the aircraft including at least one standard seat of a first width and at least one reduced seat of a second width;
allowing children to sit in the at least one reduced seat while restricting adults from sitting in the at least one reduced seat.
